(19) United States
(12) Patent Application Publication
(10) Pub. No.: US 2006/0107219 A1
(43) Pub. Date: May 18, 2006

(54) Method to enhance user interface and target applications based on context awareness

(75) Inventors: Deepak P. Ahya, Plantation, FL (US); Daniel A. Baudino, Lake Worth, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/853,947

(22) Filed: May 26, 2004

(51) Int. Cl. G06F 17/00

(52) U.S. Cl. 715/745

(57) ABSTRACT

A method (100) to enhance user interface and target applications based on context awareness can include tracking (102) the number of times an event occurs during a given time, tracking (104) the time between user initiated events, generating (112) a pattern from the tracking steps, associating (113) the pattern with a user profile, and configuring (116) the user interface and the operation of an application based on the user profile. The tracking steps can track usage of the user interface at different times, dates, locations or in different environments or contexts as detected by changes in time of day, date, location, environmental input, user habit, or user application. The pattern can optionally be generated (114) dynamically corresponding with changes in the user profile. In this regard, the method can dynamically adapt (118) configurable options based on a detected change in context.

### CROSS-REFERENCE TO RELATED APPLICATIONS

See Docket No. 7463-53 and 7463-54 concurrently filed herewith.

### FIELD OF THE INVENTION

This invention relates generally to user interfaces, and more particularly to a method and system for enhancing user interfaces and applications based on context.

### BACKGROUND OF THE INVENTION

As mobile devices and other electronic appliances become increasingly feature rich, their respective user interfaces are getting more complex. Marketing studies have indicated that approximately 90% of the users seem to be using 10% of the features available. Part of the blame can be placed on the complexity of the overall user interface and more specifically because users get lost in the Main Menu or Application Menus. Since many products today are designed to satisfy the needs of many, an inordinate amount of logical options are provided for Main menus and Application menus. Unfortunately, the numerous options result in a significant number of key presses or steps for all users.

Existing UIs use soft/hot keys to allow a user a direct link to some applications. The existing soft/hot keys are sometimes user programmable, but remain static once programmed by the user. Some devices offer profiles, but the profiles are manually set or pre-loaded by a device manufacturer and fail to have actual knowledge of the context in which a user operates his or her device or knowledge of a user's usage pattern at all. In such systems, a user typically activates the profiles manually. Such systems having mobile users unfortunately fail to dynamically adapt to different environments. Even stationary users can experience different environments and modes of operation that again fail to dynamically adapt to enhance a user's experience on a device having a user interface.

Soft/hot keys help the user to reduce the number of keystrokes to execute a desired application and to optimize the UI based on the features/applications available and their intended use. Unfortunately, since existing soft/hot key features are static, no consideration is given by the soft/hot key function to the context in which a user is currently operating a device. What may have been a desired link or hot key at one instant in time, place or application, may very well change as a result of use of a device at a different time, place or application. Existing hot/soft keys features fail to provide a dynamically changing hot/soft key function based on changing context. Existing hot/soft key functions also fail to account for a user's habits in traversing through application menus, submenus and the like.

Although there are systems that change computer user interfaces based on context, such schemes use limited templates that are predefined and fail to learn from a user's habits to re-organized menus (as well as submenus and application menus) and fail to provide smart assist messages. In yet other existing systems by Microsoft Corporation for example, task models are used to help computer users complete tasks. In this scheme, tasks are viewed in a macro sense such as writing a letter. User inputs are collected in the form of tasks that are then logged and formatted in a such a way (adds a parameter) that they can be parsed into clusters (similar tasks). The application uses this information to complete tasks or provide targeted advertisement. Again, such systems fail to learn from a user's habits and fail to provide smart assist messages. In yet another scheme, a teaching agent that “learns” and provides an advisory style (as oppose to assistant style) help agent exists. The agent is a computer program which simulates a human being and what another human being would do. Such a system fails to analyze a user's work as it is deemed computationally impractical if such a system tries to learn or understand semantics. It breaks down users into experts, intermediate and novice. The user background is stored in adaptive frames. The system learns about user competency based on adaptive frames information. In a nutshell, such a system focuses on modeling a user to understand the competency level so pre-programmed advisory style help can be provided (e.g. appropriate level of examples, guidance on goal achievement etc.) Such a system uses a competence assessment to go to pre-programmed messages and examples. Such a system fails to focus on understanding where a user has been in the past and what are the likely places he/she might be going. Furthermore, the users habits such as hesitation and other actions are not viewed to provide smart pop ups.

### SUMMARY OF THE INVENTION

Embodiments in accordance with the present invention can provide mobile users with an optimized UI for a given environment or context. What may have an been a ideal user interface or allocation of resources in one context or environment can change in a different context or environment.

In a first embodiment of the present invention, a method of enhancing user interface and target applications based on context awareness can include the steps of tracking events initiated by a user on a device having a user interface and at least one application, tracking the number of times an event occurs during a given time, and tracking the time between user initiated events. The method can further include the steps of generating a pattern from the tracking steps, associating the pattern with a user profile, and configuring the user interface and the operation of the at least one application based on the user profile. Note that the tracking steps can include tracking usage of the user interface at different times, dates, locations or in different environments or contexts as detected by changes in time of day, date, location, user biometric input, external environmental input, user habit, and user application. Also note that the pattern can be generated dynamically such that the user profile can change dynamically as the pattern changes. In this regard, the method can dynamically adapt configurable options such as hot/soft keys, menus, shortcuts, quick links, or any other configurable option on at least one among a main menu on a user interface, a sub-menu on a user interface, a menu for an application, or a sub-menu for an application based on a detected change in context.

In a second embodiment of the present invention, another method of optimizing a user interface based on applications and environment can include the steps of tracking a user's habits and a user's environment, generating a dynamic user profile based on the user's habits and the user's environment, and dynamically identifying performance enhancements for use of the user interface and applications based on the dynamic user profile. Such performance enhancements can include reducing the accessibility of unused functions in at least one among the user interface and the applications or the reassignment of resources to a preferred application based on the dynamic user profile. The reassignment of resources can include the reassignment of application memory for an application currently given priority by the dynamic user profile.

In a third embodiment of the present invention, a dynamically enhanced user interface can include an event tracker, a time tracker, an environmental tracker, and a user pattern profile generator receiving inputs from the event tracker, the time tracker and the environmental tracker and dynamically generating a user pattern profile in response to the inputs from the event tracker, time tracker and environmental tracker. The environmental tracker can be at least one among a light sensor, a biometric sensor, a weather sensor, and a location sensor. The user interface can further include a time of day tracker, wherein the user pattern profile generator further uses inputs from the time of day tracker. The user interface can further include a configurable option manager that manages the presentation of the user interface in response to the user pattern profile generator and an application manager that manages the functions of an application in response to the user pattern profile generator. The configurable option manager can manage the display of soft/hot keys or other configurable options on a graphical user interface of the user interface.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram learning user interface (UI) framework or architecture in accordance with an embodiment of the present invention

FIG. 2 is a block diagram of a learning UI module in accordance with an embodiment of the present invention.

FIG. 3 is a block diagram of an event/time tracker architecture for the UI module of FIG. 2 including environmental sensors, location sensors, date book tracker among other tracking devices.

FIG. 4 is an application tree diagram illustrating user behavior in two different contexts accordance with an embodiment of the present invention.

FIG. 5 is a schematic drawing of an optimized UI for a first context as indicated in FIG. 4 in accordance with an embodiment of the present invention.

FIG. 6 is a schematic drawing of an optimized UI for a second context as indicated in FIG. 4 in accordance with an embodiment of the present invention.

FIG. 7 is a flow chart illustrating a method of enhancing a user interface and target applications based on context awareness in accordance with an embodiment of the present invention.

FIG. 8 is a flow chart illustrating another method of enhancing a user interface and target applications based on context awareness in accordance with an embodiment of the present invention

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

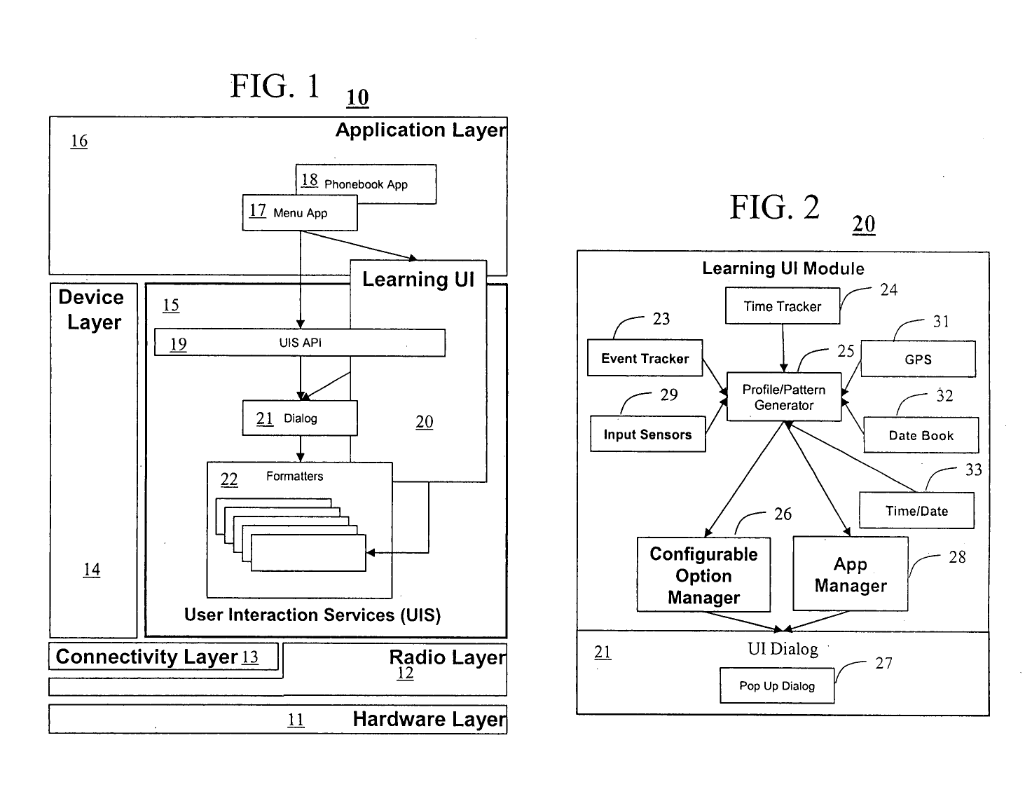

Mobile users access different applications in different environments and have a need for an optimized UI for the given environment/context. In this regard a method and system of enhancing a user interface and target applications based on context awareness can include a learning user interface architecture 10 as illustrated in FIG. 1. The architecture 10 is suitable for most electronic appliances and particularly for mobile devices although desktop appliances can equally benefit from the concepts herein. The architecture 10 can include a hardware layer 11 and a hardware abstraction or engine layer 12 as well as an optional connectivity layer 13. The architecture 10 can further include a device layer 14 that can include a user interaction services (UIS) module 15. The device layer 14 can define the functions and interactions that a particular device such as a cellular phone, laptop computer, personal digital assistant, MP3 player or other device might have with the remainder of the architecture. More likely, the UIS module 15 can be a separate module interacting responsively to the device layer 14 and other layers in the architecture 10. The architecture 10 can further include an ergonomic layer 16 that can include one or more applications such as a menu application 17 and a phonebook application 18 as examples.

The UIS module 15 can include a UIS application programming interface (API) 19 and a Learning User Interface (UI) module 20 that receives inputs from the ergonomics layer 16. The UIS API 19 and the Learning UI module 20 can provide inputs to a dialog block 21. The dialog block 21 and the Learning UI can also correspondingly provide inputs to a formatter 22.

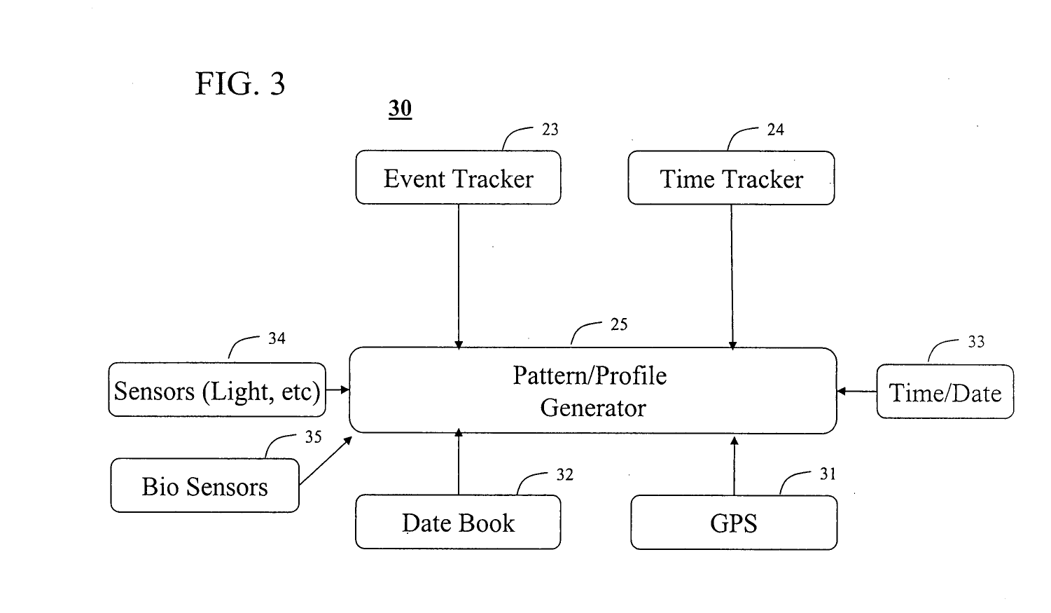

Referring to FIGS. 1 and 2, the dialog block 21 can provide a user with assistance in various forms using pop-up dialogs 27 for example although other dialogs are certainly contemplated herein for example a text to voice dialog that also uses voice recognition for receiving inputs from the user. Referring to FIG. 2, the Learning UI module 20 can include an event tracker 23, a time tracker 24, a profile/pattern generator 25, an application manager 28 and configurable option manager 26 that can manage soft/hot keys among other configurable options. In a specific embodiment, the configurable option manager 26 can be a hot/soft key manager. The event tracker 23 can record key sequences, UI Start and end events (actions), applications launched, and other events. The event tracker can track a main event such as the launch of an application and then track subsequent events such as the user's traversal through menu and sub-menu selections within the application. The time tracker 24 can include a macroscopic and a microscopic time monitor. The macroscopic time module can monitor the number of times a particular event pattern occurs within a given time whereas the microscopic time module detects the gap or elapsed time between key presses. The microscopic time module enables the detection of pauses between key presses. The time tracker 24 is primarily used to detect when and how often the events occurred. Other inputs to the profile pattern generator 25 can also include a date book 32 that can have scheduled information for the user, a time/date input 33 that can provide time of day and calendar information that would be pertinent in determining a user's profile or habits as well as a location device such as a GPS 31 that provides further context in terms of location. For example, a user at home might only run MP3 and game related applications whereas a user at work might run word processing, spreadsheet applications, or wireless communication applications such as wireless email. Other environmental inputs can include input sensors 29 that will be further detailed with respect to FIG. 3 below.

The pattern/profile generator 25 records the behavior of the user on time and can use the information from the tracking modules mentioned above to process them to produce patterns, and associations creating a unique profile for a user based on patterns detected. The user behavior can include how, when and where applications are launched, how long the applications are used, intervals between usages and other user behavior patterns. In a simpler view as shown in FIG. 3, a learning UI module and event/time tracker architecture 30 can just include an event tracker 23, a time tracker 24, and a pattern/profile generator 25 all functioning as similarly described with respect to the event tracker, time tracker, and pattern/profile generator of FIG. 2. Furthermore, since the learning UI Framework or module is used to create a context sensitive user interface unique or at least more finely tailored to a user, other inputs can be used to track the usage of the UI features at different times, dates, locations, and at other input conditions (health information from bio-sensors), to provide an even more customized and user friendly interface intuitive to each user. Such other sensors can include, but is certainly not limited to, external environmental sensors such as light sensors 34 or temperature sensors and other sensors such as biometric sensors 35. The event/time tracker (23 and 24) records the user's habits and usage. The pattern/profile generator 25 uses the recorded information and can link it to the location based information (GPS input), personal information (Bio Sensors), time of the day, vacations, weekends/weekdays, day and night to generate an expanded profile. Based on the new profile generated, the system can optimize the UI to allow direct access to preferred applications and preferred sub-menus under the conditions recorded.

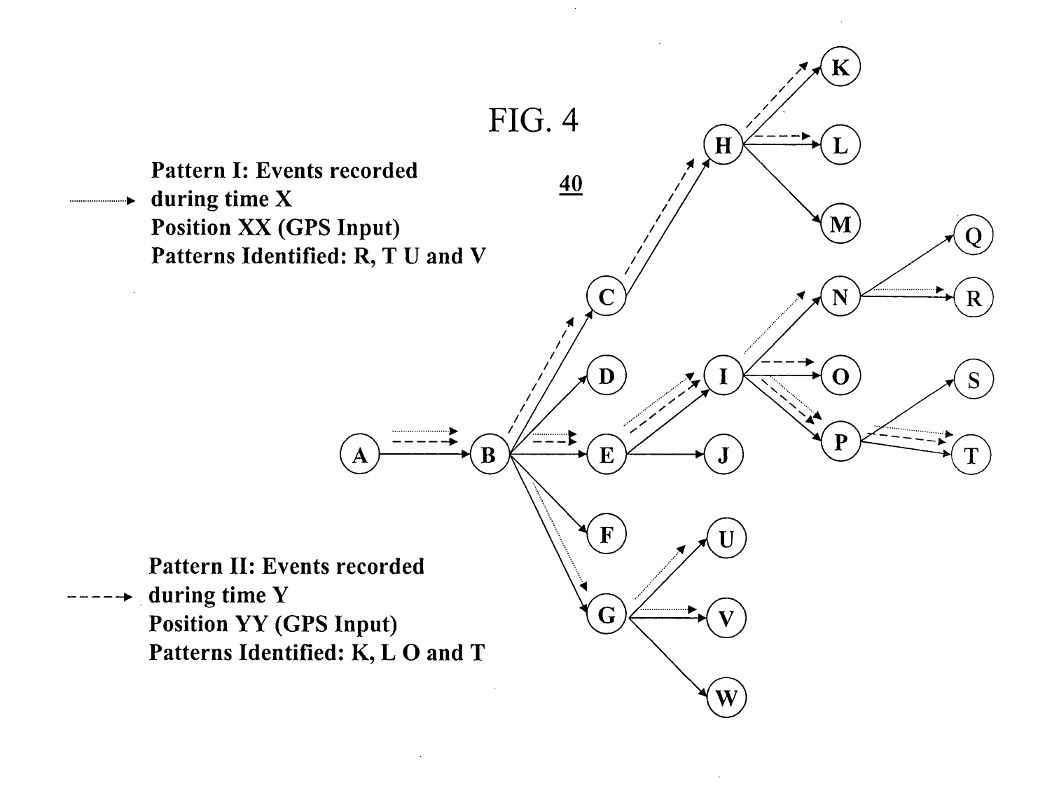

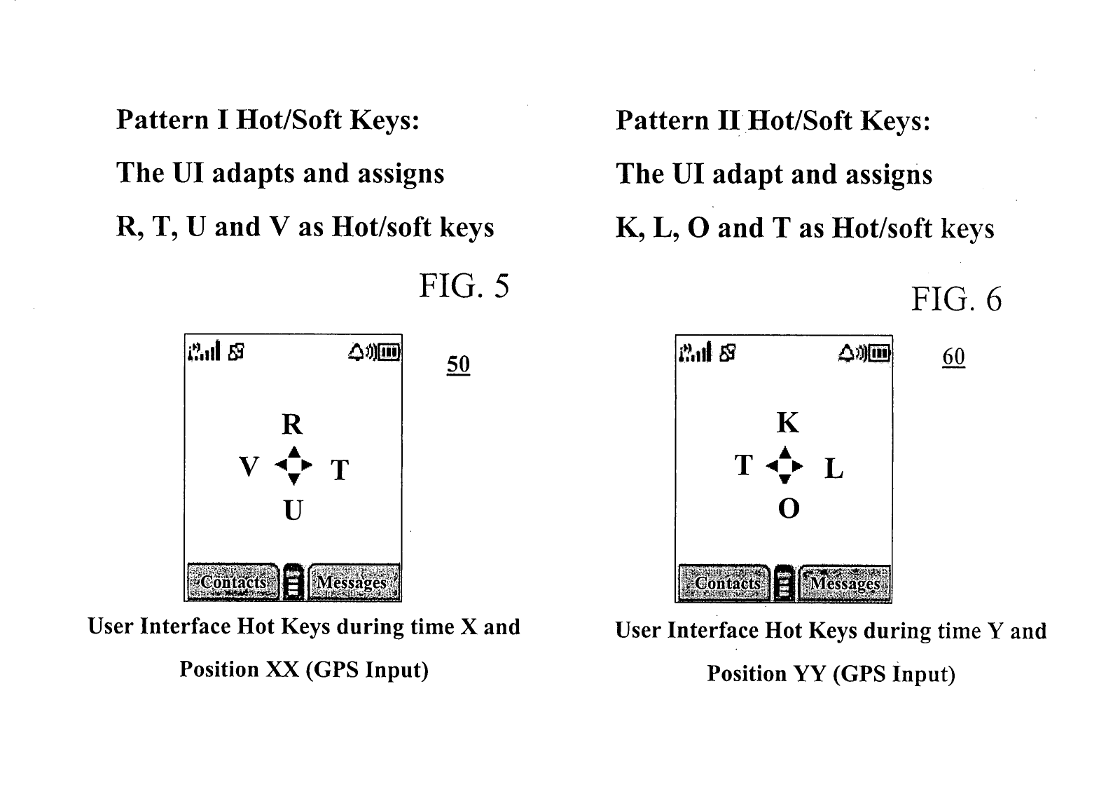

Several use case scenarios are illustrated in FIGS. 4-6 in accordance with an embodiment of the present invention. For example, the pattern generator can use the information on a date book (week day, weekend, business trip, holidays, out of the office on a week day, etc) to optimize a device for a particular user based on their habits. A first pattern such as Pattern I might be optimized for entertainment applications. For example, MP3 player functions and Internet browsing can be set to be optimized while a user is waiting at a train station out of the usual office hours. While in another setting, a second pattern such as Pattern II might be optimized for business purposes based on information indicating use during business hours at a usual place of business. As shown in the application tree 40 of FIG. 4, Pattern I can have recorded events during a first detected time and place that identifies applications R, T, U, and V (light lines) as the prevalent applications in this first context whereas Pattern II can have recorded events during a second detected time and place that identifies applications K, L, O, and T (dashed lines) as the prevalent applications in this second context. As shown in the user interfaces 50 and 60 respectively of FIGS. 5 and 6, configurable options such as hot/soft keys can be adapted for quick access to the prevalent applications R, T, U, and V during the first context and then changed or adapted for quick access to the prevalent applications K, L, O, and T during the second context.

In another scenario, a message delivery system can be tailored based on context that is based on message content and time of day. For example, a system that can distinguish between business messages and family related messages can have a different delivery system or accessibility based on business hours. For example, family and business messages can be delivered to different folders or highlighted and a UI can adapt the folder access according to the context. For example, easy and/or direct access to business messages can be given during business hours while easy and/or direct access to family messages can be given during out of work hours or weekends or holidays. Furthermore, a system can be adapted to provide performance enhancement of a particular device, application or component by releasing some resources and tasks that may not be needed to run. For example, memory can be reassigned for runtime applications and other memory can be used in the background based on user habits and context.

In summary, several embodiments provide systems and methods to optimize a UI based on application manager and configurable option managers that can use information gathered on user habits and captured by a profile generator. A context sensitive user profile can be generated based on inputs from GPS, biosensors, and other inputs. As a result, areas where performance of targeted applications and user interfaces can be improved based on the habits and the environment can be identified. In some embodiments, the improvements can involve shutting off unused tasks as well as reassigning resources to preferred applications.

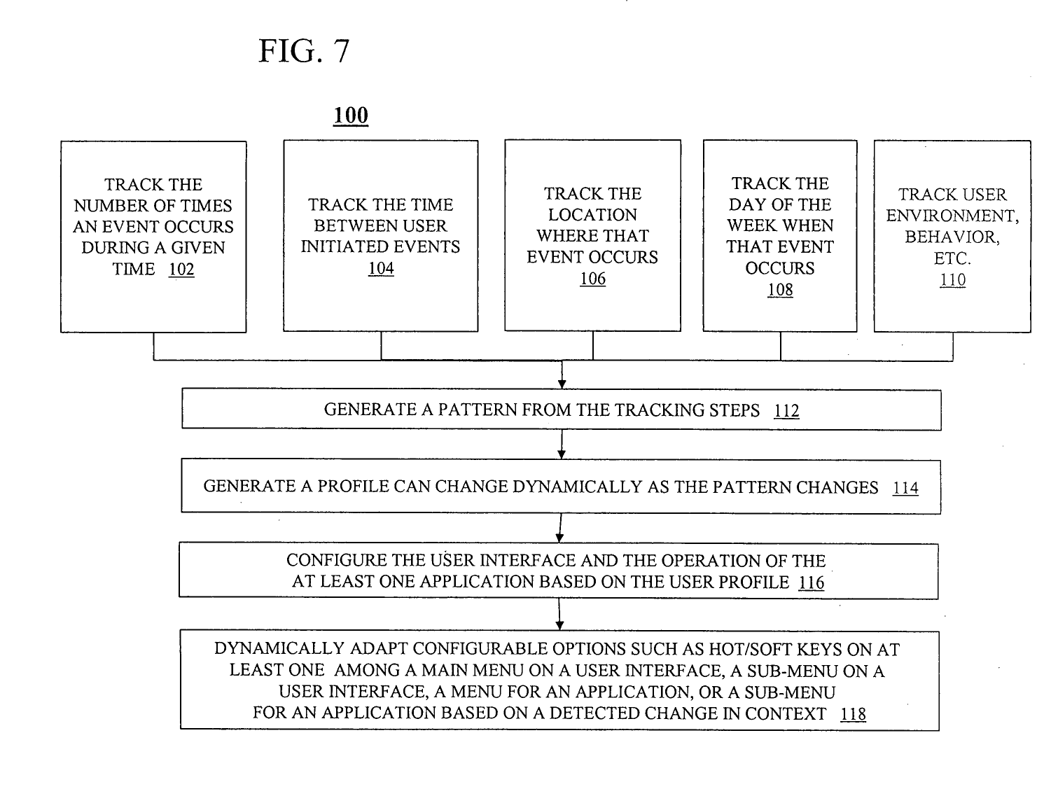

Referring to FIG. 7, a flow chart illustrating a method 100 to enhance user interface and target applications based on context awareness is shown. The method 100 can include several tracking steps including the step 102 of tracking the number of times an event occurs during a given time, the step 104 of tracking the time between user initiated events, the step 106 of tracking the location where an event occurs, the step 108 of tracking the day of the week when the event occurs, and the step 110 of tracking a user environment or behavior. The method 100 can further include the step 112 of generating a pattern from the tracking steps, optionally associating the pattern with a user profile at step 113, optionally generating a profile that can change dynamically as the pattern changes at step 1114, and configuring at step 116 the user interface and the operation of at least one application based on the user profile. In this regard, the method 100 can dynamically adapt configurable options such as hot/soft keys on at least one among a main menu on a user interface, a sub-menu on a user interface, a menu for an application, or a sub-menu for an application based on a detected change in context at step 118. Note that the tracking steps can include tracking usage of the user interface at different times, dates, locations or in different environments or contexts as detected by changes in time of day, date, location, user biometric input, external environmental input, user habit, and user application.

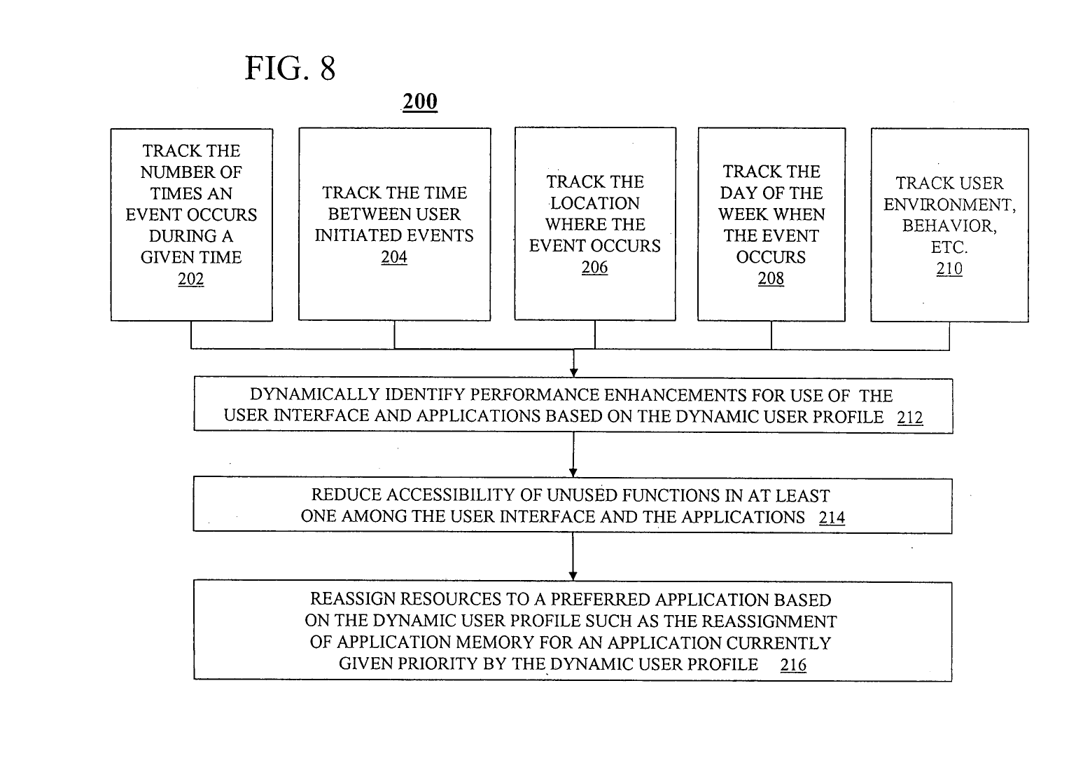

Referring to FIG. 8, a flow chart illustrating another method 200 of optimizing a user interface based on applications and environment is shown. The method 200 can include several tracking steps including the step 202 of tracking a number of times that an event occurs during a given time, tracking the time between user initiated events at step 204, tracking the location where the events occurs at step 206, tracking the day of the week when the event occurs at step 208, and tracking the user's habits or environment at step 210. The method can further include the step 212 of generating a dynamic user profile and dynamically identifying performance enhancements for use of a user interface and applications based on the dynamic user profile at step 212. Such performance enhancements can include reducing the accessibility of unused functions at step 214 in at least one among the user interface and the applications. The method can also include the step of reassigning of resources at step 216 to a preferred application based on the dynamic user profile. The reassignment of resources can include the reassignment of application memory for an application currently given priority by the dynamic user profile.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could by a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method to enhance user interface and target applications based on context awareness, comprising the steps of:
tracking events initiated by a user on a device having a user interface and at least one application;
tracking the number of times an event occurs during a given time;
tracking the time between user initiated events;
generating a pattern from the tracking steps;
associating the pattern with a user profile; and
configuring the user interface and the operation of the at least one application based on the user profile.

2. The method of claim 1, wherein the method further comprises the step of tracking usage of the user interface at different times, dates, and locations.

3. The method of claim 1, wherein the step of generating the pattern occurs dynamically and the method further comprises the step of changing the user profile dynamically as the pattern changes.

4. The method of claim 3, wherein the method further comprises the step of dynamically adapting configurable options on at least one among a main menu on a user interface, a sub-menu on a user interface, a menu for an application, and a sub-menu for an application based on a detected change in context.

5. The method of claim 4, wherein the change in context is selected among a change in time of day, date, location, user biometric input, external environmental input, user habit, and user application and wherein the configurable options are selected among hot/soft keys, menus, shortcuts, and quick links.

6. A method of optimizing a user interface based on applications and environment, comprising the steps of:
tracking a user's habits and a user's environment;
generating a dynamic user profile based on the user's habits and the user's environment; and
dynamically identifying performance enhancements for use of the user interface and applications based on the dynamic user profile.

7. The method of claim 6, wherein the method further comprises the step of reducing accessibility of unused functions in at least one among the user interface and the applications.

8. The method of claim 6, wherein the method further comprises the step of reassigning resources to a preferred application based on the dynamic user profile.

9. The method of claim 8, wherein the step of reassigning resources comprises the step of reassigning application memory for an application currently given priority by the dynamic user profile.

10. A dynamically enhanced user interface, comprising:
an event tracker;
a time tracker;
an environmental tracker; and
a user pattern profile generator receiving inputs from the event tracker, the time tracker and the environmental tracker and dynamically generating a user pattern profile in response to said inputs.

11. The user interface of claim 10, wherein the environmental tracker comprises at least one among a light sensor, a biometric sensor, a weather sensor, and a location sensor.

12. The user interface of claim 10, wherein the user interface further comprises a time of day tracker, wherein the user pattern profile generator further uses inputs from the time of day tracker to generate the user pattern profile.

13. The user interface of claim 10, wherein the user interface further comprises a configurable option manager that manages the presentation of the user interface in response to the user pattern profile generator.

14. The user interface of claim 13, wherein the user interface further comprises an application manager that manages the functions of an application in response to the user pattern profile generator.

15. The user interface of claim 13, wherein the configurable option manager comprises a soft/hot key manager that manages the display of soft/hot keys on a graphical user interface of the user interface.

16. A machine readable storage, having stored thereon a computer program having a plurality of code sections executable by a machine for causing the machine to perform the steps of:
tracking events initiated by a user on a device having a user interface and at least one application;
tracking the number of times an event occurs during a given time
tracking the time between user initiated events;
generating a pattern from the tracking steps; and
associating the pattern with a user profile.

17. The machine readable storage of claim 16, wherein the machine readable storage is further programmed to cause the machine to track usage of the user interface at different times, dates, and locations.

18. The machine readable storage of claim 16, wherein the machine readable storage is further programmed to cause the machine to dynamically generate the pattern and further programmed to change the user profile dynamically as the pattern changes.

19. The machine readable storage of claim 18, wherein the machine readable storage is further programmed to cause the machine to dynamically adapt hot/soft keys on at least one among a main menu on a user interface, a sub-menu on a user interface, a menu for an application, and a sub-menu for an application based on a detected change in context.

20. The machine readable storage of claim 19, wherein the machine readable storage is further programmed to cause the machine to determine the detected change in context by detecting a change among a change in time of day, date, location, user biometric input, external environmental input, user habit, and user application.
